(19) United States
(12) Patent Application Publication
(10) Pub. No.: US 2026/0044352 A1
(43) Pub. Date: Feb. 12, 2026

(54) ELECTRONIC DEVICE CONTROLLING EXECUTION OF WEB APPLICATION AND METHOD FOR OPERATING THE SAME

(71) Applicant: SAMSUNG ELECTRONICS CO., LTD., Suwon-si (KR)

(72) Inventors: Yongman SON, Suwon-si (KR); Donghyun Song, Suwon-si (KR)

(73) Assignee: SAMSUNG ELECTRONICS CO., LTD., Suwon-si (KR)

(21) Appl. No.: 19/278,130

(22) Filed: Jul. 23, 2025

Related U.S. Application Data
(63) Continuation of application No. PCT/KR2025/008100, filed on Jun. 12, 2025.

(30) Foreign Application Priority Data
Aug. 7, 2024 (KR) 10-2024-0105367

(51) Int. Cl. G06F 9/445

(52) U.S. Cl. CPC G06F 9/44505

(57) ABSTRACT

An electronic device includes, memory storing instructions; and at least one processor, wherein the instructions, when executed by the at least one processor, cause the electronic device to initiate, via a second thread operating in parallel with a first thread, a pre-connection with at least one web server indicated in a first pre-connection server list of a first web application, while performing, via the first thread, at least one initialization operation for executing the first web application based on a launch request of the first web application; and enable a communication connection, via the pre-connection, to the at least one web server, before a web resource request for the at least one web server is generated.

### CROSS-REFERENCE TO RELATED APPLICATIONS

This application is a by-pass continuation application of International Application No. PCT/KR2025/008100, filed on Jun. 12, 2025, which is based on and claims priority to Korean Patent Application No. 10-2024-0105367, filed on Aug. 7, 2024, in the Korean Intellectual Property Office, the disclosures of which are incorporated by reference herein in their entireties.

### BACKGROUND

### 1. Field

The disclosure relates to an electronic device controlling execution of a web application and a method for operating the same.

### 2. Description of Related Art

A web application is a software program that may be accessed through a web browser. The web applications may be executed through the Internet. The web application may provide various services based on the interaction between the server and the client. For example, when accessing a web address (e.g., a website) through a browser, the web server of the website may provide the web application. The web application may display a screen provided by the web server, and if a function (e.g., an icon) displayed on the screen or a value is input to an input window, it may be retransmitted to the web server.

Web applications are used in various forms, and may include portal sites, online shopping malls, social media, e-mail services, and video streaming platforms.

Recently, various smart TVs (also referred to as Internet TVs) have been released that may be connected to the Internet to view various digital contents. Unlike other TVs, smart TVs may run various applications, such as a web application as a representative example, by including an operating system and a web browser.

The smart TV may have various web applications installed and used thereon, through which movies, TV programs, news, real-time streaming services, or games, for example, are available. The smart TV may be significantly influenced by the Internet speed because it has lots of web applications provided through Internet connection. In slow-Internet environments, execution of the application may be delayed, causing the smart TV less attractive.

### SUMMARY

According to an aspect of the disclosure, an electronic device includes, memory storing instructions; and at least one processor, wherein the instructions, when executed by the at least one processor, cause the electronic device to initiate, via a second thread operating in parallel with a first thread, a pre-connection with at least one web server indicated in a first pre-connection server list of a first web application, while performing, via the first thread, at least one initialization operation for executing the first web application based on a launch request of the first web application; and enable a communication connection, via the pre-connection, to the at least one web server, before a web resource request for the at least one web server is generated.

The second thread may be a network thread, and the instructions, when executed by the at least one processor, may cause the electronic device to establish the pre-connection, via the communication connection, in response to the network thread is in an idle state, after the at least one network initialization operation is completed.

The electronic device may further include a display, the first thread may be a browser thread, and the instructions, when executed by the at least one processor, may cause the electronic device to transmit to the second thread, via the browser thread, a first web resource request corresponding to a start screen of the first web application, during a browser initialization operation; receive, via the second thread, a first web resource; render the start screen based on the first web resource; and display, via the display, the start screen.

The instructions, when executed by the at least one processor, may cause the electronic device to enable, based on the pre-connection and an HTTPS protocol, with respect to a first web server, at least one of domain address identification including a domain name service (DNS) lookup, communication connection identification including a transmission control protocol (TCP) handshake, or communication security connection initialization including transport layer security (TLS).

The instructions, when executed by the at least one processor, may cause the electronic device to identify, based on the second thread receiving the first web resource request from the first thread, whether the communication connection is established with a first web server corresponding to the first web resource request; and receive, via the second thread, based on the communication connection being established, a first web resource indicated in the first web resource request from the first web server.

The instructions, when executed by the at least one processor, may cause the electronic device to receive the first web resource from the first web server, via the second thread, after initiating the communication connection with the first web server, based on determining the communication connection with the first web server is not established.

The instructions, when executed by the at least one processor, may cause the electronic device to transmit the first web resource to a third thread, via the second thread; and transmit, via the third thread, a second web resource request to the second thread, wherein the second web resource request is generated while the first web resource is being parsed.

The instructions, when executed by the at least one processor, may cause the electronic device to collect information, about the web resource request, that is generated until the at least one initialization operation is completed, wherein the information including information about a web server that initiates a communication connection according to the web resource request; and apply the information that is collected to the first pre-connection server list.

The memory may include a first memory that is at least one of a non-volatile memory or a separate storage, and the instructions, when executed by the at least one processor, may cause the electronic device to store the first pre-connection server list in the memory at a first time based on the at least one initialization operation being completed or a second time based on the first web application having transitioned to a background state.

The start screen may include at least one user interface, and the start screen may include one or more consecutive screens.

A method performed by an electronic device includes initiating, via a second thread operating in parallel with a first thread, a pre-connection with at least one web server indicated in a first pre-connection server list of a first web application, while performing, via the first thread, at least one initialization operation for executing the first web application based on a launch request of the first web application; and enabling a communication connection, via the pre-connection, to the at least one web server, before a web resource request for the at least one web server is generated.

The second thread may be a network thread, and the method may further include establishing the pre-connection, via the communication connection, in response to the network thread is in an idle state, after the at least one network initialization operation is completed.

The first thread may be a browser thread, and the method may further include transmitting, to the second thread via the browser thread, a first web resource request corresponding to a start screen of the first web application, during a browser initialization operation; receiving, via the second thread, a first web resource; rendering the start screen based on the first web resource; and displaying, via a display of the electronic device, the start screen.

The performing the pre-connection to the at least one web server may include enabling, based on the pre-connection and an HTTPS protocol, with respect to a first web server, at least one of domain address identification including a domain name service (DNS) lookup, communication connection identification including a transmission control protocol (TCP) handshake, or communication security connection initialization including transport layer security (TLS).

The method may further include identifying, based on the second thread receiving the first web resource request from the first thread, whether the communication connection is established with a first web server corresponding to the first web resource request; and receiving, via the second thread, based on the communication connection being established, a first web resource indicated in the first web resource request from the first web server.

The method may further include receiving the first web resource from the first web server, via the second thread, after initiating the communication connection with the first web server, based on determining the communication connection with the first web server is not established.

The method may further include transmitting the first web resource to a third thread, via the second thread; and transmitting, via the third thread, a second web resource request to the second thread, wherein the second web resource request is generated while the first web resource is being parsed.

The method may further include collecting information, about the web resource request, that is generated until the at least one initialization operation is completed, wherein the information including information about a web server that initiates a communication connection according to the web resource request; and applying the information that is collected to the first pre-connection server list.

The method may further include storing the first pre-connection server list in memory at a first time based on the at least one initialization operation being completed or a second time based on the first web application having transitioned to a background state, wherein the memory is a non-volatile memory or a separate storage device.

The start screen may include at least one user interface, and the start screen may include one or more consecutive screens.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates an electronic device and web servers according to an embodiment;

FIG. 2 illustrates an example of a start screen of a web application of an electronic device according to an embodiment;

FIG. 3 illustrates an example of a pre-connection server list of a web application according to an embodiment;

FIG. 4 is a flowchart illustrating operations of controlling start execution of a web application by an electronic device according to an embodiment;

FIG. 5 is a flowchart illustrating operations of a plurality of threads according to web application start of an electronic device according to an embodiment;

FIG. 6 illustrates an example of a network thread operation according to start of a web application on an electronic device according to an embodiment;

FIG. 7 illustrates an example of a data communication time between an electronic device 101 and a web server according to an embodiment;

FIG. 8 illustrates another example of a network thread operation according to start of a web application on an electronic device according to an embodiment;

FIG. 9 illustrates an example of an operation of storing a pre-connection server list for a web application by an electronic device according to an embodiment;

FIG. 10 is a flowchart illustrating operations of processing a URL request of a web application by an electronic device according to an embodiment;

FIG. 11 illustrates an example of a pre-connection server list update for a web application on an electronic device according to an embodiment; and

FIG. 12 is a block diagram illustrating components of an electronic device according to an embodiment.

### DETAILED DESCRIPTION

The embodiments described in the disclosure, and the configurations shown in the drawings, are only examples of embodiments, and various modifications may be made without departing from the scope and spirit of the disclosure.

Embodiments are described in detail with reference to the drawings so that those skilled in the art to which the disclosure pertains may practice the disclosure. The disclosure may be implemented in other various forms and is not limited to the embodiments set forth herein. The same or similar reference denotations may be used to refer to the same or similar elements throughout the disclosure.

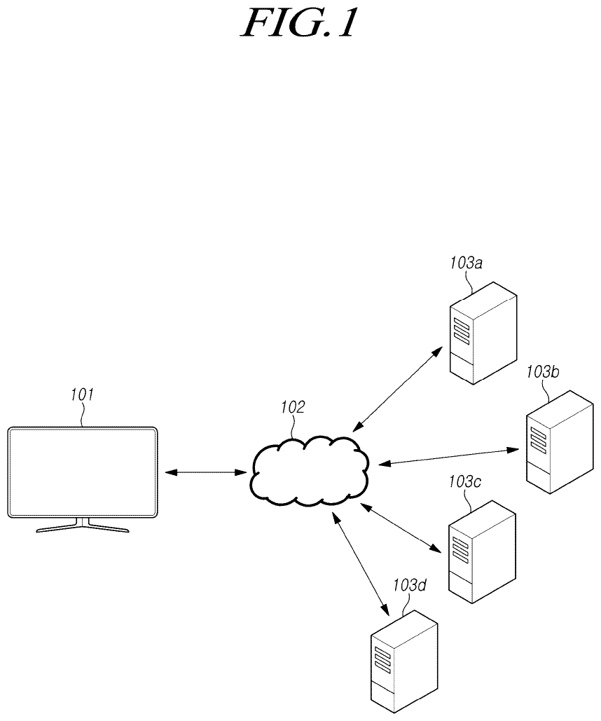

FIG. 1 illustrates an electronic device and web servers according to an embodiment.

According to an embodiment, the electronic device 101 may include one or more web applications and may be connected to web servers through a wireless communication network 102. A web application is a software application that may be accessed and used through a web browser. The web application is based on the client-server model, and the client device (e.g., the electronic device 101) may access the application hosted on the server (e.g., web servers 103a, 103b, 103c, and 103d) through the web browser and use various functions. For example, the web application that provides over-the-top (OTT) content may use one or more web servers (e.g., Apache HTTP server, Nginx, LiteSpeed, Caddy, or Microsoft Internet Information Services) to provide various types of content (e.g., movies, dramas, sports, or games) to the electronic devices 101, which is the client device.

The electronic device 101 according to an embodiment may be a display device such as a TV, but the disclosure is not limited thereto. For example, the electronic device 301 may be a mobile device, a wearable device, a tablet, a desktop, a laptop, or a game console.

According to an embodiment, the web server 103a, 103b, 103c, or 103d may receive a web resource request from the client device (e.g., the electronic device 101) based on a communication protocol supporting the web browser, and may transmit the web resource to the client device 101 in response to the request.

According to an embodiment, the web resource may be defined by a protocol used to communicate with the web browser. The type of web resource may include, e.g., an hypertext markup language (HTML) file, a cascading style sheets (CSS) file, a JavaScript file, an image file, a video file, an audio file, a document file, an icon file, a font file, an asynchronous JavaScript and XML (AJAX) request, or an application programming interface (API) endpoint. Some web resources may include one or more other web resource requests. For example, the HTML file may further include at least one of an image file, a document file, or a font file.

According to an embodiment, the types of communication protocols that support the web browser may include hypertext transfer protocol (HTTP), hypertext transfer protocol secure (HTTPS), file transfer protocol (FTP), secure file transfer protocol (SFTP), WebSocket, HTTP/2, or HTTP/3. The type of communication protocol may be added according to the development of communication technology, and the standard of the communication protocol may be changed, added, or deleted according to the development of communication technology.

According to an embodiment, the electronic device 101 may establish a communication channel based on a protocol (e.g., HTTPS) supporting the web browser with at least one of the web servers 103a to 103d using the communication interface while executing the web application, and perform data communication (e.g., web resource request or web resource transmission/reception) through the established communication channel. If the communication connection speed with the web server is slowed according to the communication environment of the wireless network 102, the execution speed of the web application may also be affected.

According to an embodiment, the electronic device 101 may initiate a communication connection to at least some of the at least one web server corresponding to the at least one web resource request before at least one web resource request to start (or launch) the web application is generated for stable web application execution even in various wireless network environments. For example, the electronic device 101 may render the start screen of the first web application by parsing the first web resource (e.g., Home URL request) corresponding to the start screen of the first web application according to the start of the first web application. The electronic device 101 may initiate pre-connection with at least some of the at least one web server before parsing the first web resource for at least one web server that performs communication connection according to at least one web resource request extracted while parsing the first web resource. Establishing only a communication connection with web servers included in the pre-connection list before fetching or parsing web resources may be referred to as “pre-connection”. Pre-connection may be performed to establish network-layer connections with web servers in advance, without downloading or parsing any actual resources, and may be distinguished from prefetch or preload, which involve fetching resources ahead of time.

The electronic device 101 is not limited by the type or specification of the communication protocol, and may initiate pre-connection with some web servers regardless of the type or specification of the communication protocol. In response to the start of the web application, the electronic device 101 may perform only a communication connection with at least one web server included in the pre-connection web server list in advance, and then receive the web resource directly from the web server in response to the web resource request for the already connected web server being generated. The electronic device 101 may establish a communication channel in advance for the web server corresponding to the web resource before the web resource request is extracted. The electronic device 101 may store web servers where the web resource requests have been generated in a pre-connected web server list during the launch process according to the previous start of the web application. The electronic device 101 may initiate a pre-connection using a pre-connection web server list stored by the previous start at the next start of the web application.

According to an embodiment, the electronic device 101 may include one or more web applications, and the web application may request or transmit/receive web resources with one or more web servers based on a protocol supporting the web browser. Throughout the disclosure, “web resource request or web resource transmission/reception” may be referred to as “data communication” for convenience of description. “Communication connection” with the web server may refer to “establishing a communication channel between the web server and the client device” in advance for data communication. When the electronic device 101 performs “pre-connection” to some web servers, it may refer to establishing only a communication connection with the first web server before generating a request to connect with the first web server for retrieving web resources. The web resource request may be extracted by parsing a Home URL request called according to the start of the web application.

After performing pre-connection, the electronic device 101 according to an embodiment may immediately request/receive web resources without a communication connection process (already performed) for the web server already communication-connected at the time of processing the web resource request.

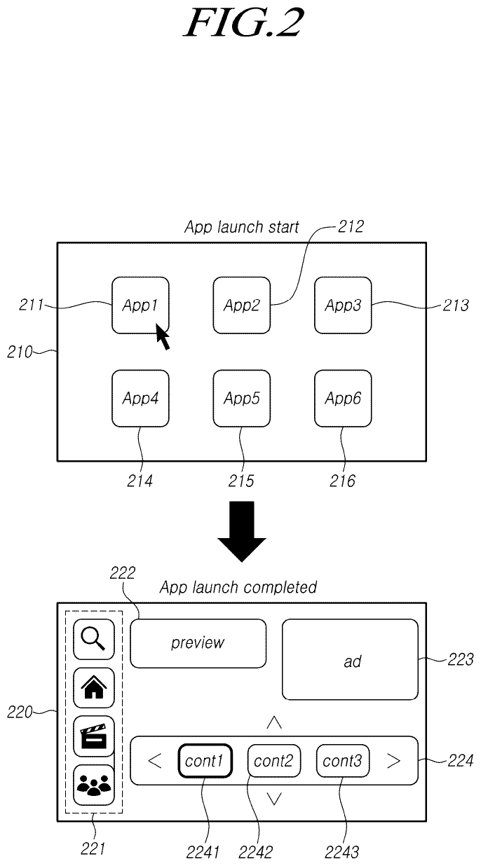

FIG. 2 illustrates an example of a start screen of a web application of an electronic device according to an embodiment.

According to an embodiment, the electronic device 101 may include one or more web applications, and may display each start screen in response to execution of each web application. The start screen may be one web resource. For example, the start screen may be written in an HTML format. In response to the start for each web application, a start screen may be displayed by parsing a designated web resource.

Referring to FIG. 2, the electronic device 101 may output a first screen 210 including a plurality of icons 211 to 216 corresponding to a plurality of applications App1 to App6, respectively, through the display. The types of applications may be various, and at least some of the plurality of applications may be web applications. For example, the first application App1 may be a web application.

According to an embodiment, in response to a request (e.g., clicking) to execute the first icon 211 corresponding to the first application App1, the electronic device 101 may start to execute the first application App1. According to an embodiment, the electronic device 101 may perform various initializations in a series of operations for starting the execution of the first application App1, and output a second screen 220 including the user interface if the initialization (or launch) is completed. The second screen may be referred to as a start screen or a home screen of the first application App1.

The second screen 220 may be determined by a default web resource (e.g., a Home URL request) designated corresponding to the first application App1. The default web resource of each application may be generated and changed by the creator who created and distributed the corresponding application.

The second screen 220 may include various user interfaces corresponding to various functions of the first application App1, and corresponds to a start screen that is in a standby state waiting for the user input in response to an execution request of the first application.

Referring to FIG. 2, the second screen 220 may include a plurality of divided areas. For example, the second screen 220 may include a first portion 221 for displaying an icon corresponding to a menu, a second portion 222 for displaying a preview of first content, a third portion 223 for displaying an advertisement, or a fourth portion 224 for displaying icons corresponding to the contents. Some of them may include the user interface. Some of them may perform rendering on a corresponding portion by performing data communication with the web server by a web resource request. For example, the icon of the first portion 221 (e.g., search, home screen movement, movie content display, user switching) may perform a function in response to a user input. The second portion 222 may correspond to a function of playing the first content in response to a user input. The first content may be received from the web server in response to a web resource request requesting the first content from the web server. The third portion 223 may correspond to a function of moving to a product homepage or a product sales page corresponding to the displayed advertisement. The fourth portion 224 may include icons 2241, 2242, and 2243 corresponding to the contents, and may provide a function of playing content corresponding to the selected icon in response to a user input for selecting each icon. Each content may be received from each web server by each web resource request. For the first content corresponding to the highlighted first icon 2241 among the icons displayed in the fourth portion 224, a preview photo or image of the first content may be displayed in the second portion 222. The content exposed through the fourth portion 224 and the icon corresponding thereto may be changed, and the next item or the previous item may be displayed in response to a user input.

In an embodiment, while displaying the start screen (e.g., the second screen 220) in response to the request to start execution of the web application (e.g., the first application App1), the electronic device 101 may perform data communication with at least one web server by one or more web resource requests included in the default web resource (e.g., Home URL request). A series of control operations of executing the web application and displaying the start screen may be constituted of instructions programmed by the creator who created and distributed the web application. For example, the default web resource may be created as an HTML file for displaying the web application's start screen, the HTML file may further include one or more web resources, and the one or more web resources may each perform data communication with the web server. According to an embodiment, the electronic device 101 may control the execution (initial execution) of the web application in addition to control operations determined in response to the execution of the web application. For example, the electronic device 101 may perform, in advance, a communication connection before the web resource request is generated for at least one web server that performed data communication in the previous start execution while executing the web application to display the start screen, and receive web resources from a pre-connected web server in response to the generation of the web resource request.

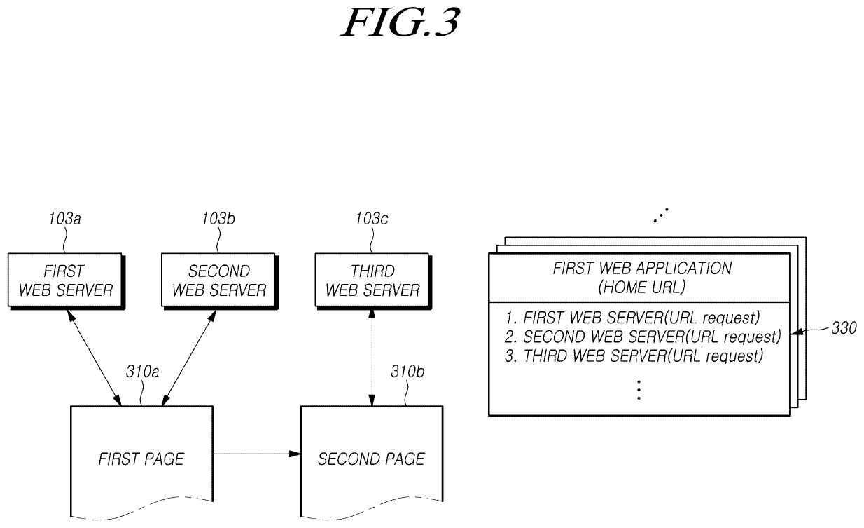

FIG. 3 illustrates an example of a pre-connection server list of a web application according to an embodiment.

According to an embodiment, the electronic device 101 may store and manage information (hereinafter, referred to as a pre-connection server list) about one or more web servers accessed while displaying a start screen including the user interface in response to the start execution of the web application.

Referring to FIG. 3, the electronic device 101 according to an embodiment may parse a default web resource (e.g., a home URL) in response to the start execution of the first web application to display the start screen. The start screen (home screen) may be one screen, or may be a plurality of screens consecutively displayed without a user input. For example, the electronic device 101 may consecutively display the first page 310a and the second page 310b at a predetermined time interval (e.g., 2 seconds) without a user input.

In an embodiment, the web server accessed by the web application may have various types and configurations. For example, the web server may provide content, provide security-related functions, provide technical back-end services, manage configuration files/settings, provide user authentication, login management, account management, monitor and manage errors, or host or manage software development kit (SDK) setting files. In various embodiments, the start screen of the web application may include various web resources through data communication with various types of web servers.

According to an embodiment, the electronic device 101 may perform data communication with the first web server 103a and the second web server 103b according to web resource requests extracted while parsing the first page 310a. According to an embodiment, the electronic device 101 may identify the second page 310b referred to from the first page 310a after parsing the first page 310a. According to an embodiment, the electronic device 101 may perform data communication with the third web server 103c according to the extracted web resource request while parsing the second page 310b.

According to an embodiment, the electronic device 101 may store the first web server 103a, the second web server 103b, and the third web server 103c accessed while parsing the first page 310a and the second page 310b in the pre-connection server list 330 for the first web application.

According to an embodiment, the electronic device 101 may store the pre-connection server list 330 in a memory. According to an embodiment, the memory may be a separate storage or a non-volatile memory so that the pre-connection server list may be maintained even while the execution of the first web application is terminated.

According to an embodiment, the electronic device 101 may minimize the start execution time of the web application based on the pre-connection server list 330 for the web application. According to an embodiment, the electronic device 101 may communication-connect with the web servers in advance by identifying the pre-connection server list 330 before a URL request to the web server is generated in response to a request for starting execution of the web application. The URL request is part of the process of requesting a web resource, and the web resource request may be used to fetch data from the web server or transmit data to the web server using a uniform resource locator (URL). The URL request may be referred to as a web resource request.

According to an embodiment, the electronic device 101 may immediately transmit and receive data to/from the web server communication-connected in advance, in response to a request for the web server, thereby reducing the total start execution time of the web application.

According to an embodiment, the electronic device 101 may include one or more web applications, and may separately store and manage each pre-connection server list for each web application. The default web resource of the web application (e.g., web resource for the start screen) may be defined and changed by the creator creating and distributing the web application. For example, the advertisement content included in the start screen of the first web application may be updated every advertising contract cycle, and the real-time relay content included in the start screen of the first web application may be updated according to a sports game schedule. In various cases, a portion of the start screen of the web application may be changed. According to an embodiment, the electronic device 101 may update and manage the pre-connection server list for each start execution of the web application.

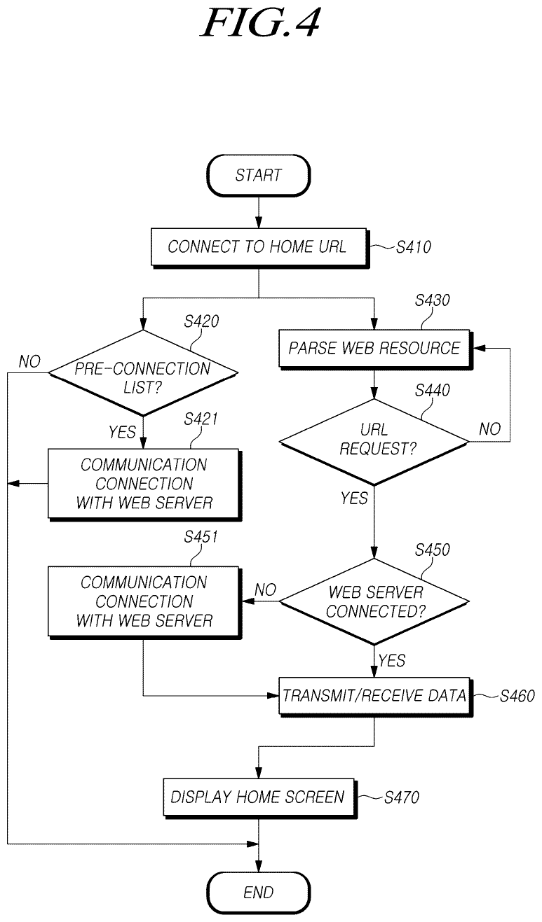

FIG. 4 is a flowchart illustrating operations of controlling start execution of a web application by an electronic device according to an embodiment.

According to an embodiment, the electronic device 101 may control at least one operation included in the start execution of the web application in response to the start request of the web application. A series of operations of the electronic device 101 according to a user input for the execution of the first web application are described with reference to FIG. 4. As an example, in the description of each operation of FIG. 4, it is also described with reference to FIG. 3.

Referring to FIG. 4, in operation S410, the electronic device 101 according to an embodiment may connect to a home page (Home URL) corresponding to the first web application in response to a request to start the first web application. The home page is for displaying a home screen (or, referred to as a start screen), and the home screen may represent an initial default screen of a user input waiting state of the first web application.

The electronic device 101 according to an embodiment may simultaneously perform operations S420 and S430 through parallel processing. For example, in response to a first web application execution request, the electronic device 101 may generate a browser thread and a network thread, perform operation S430 by the browser thread, and perform operation S420 by the network thread.

In operation S420, the electronic device 101 according to an embodiment may identify a pre-connection list for the first web application in the memory. When there is a pre-connection list, the electronic device 101 may initiate a communication connection with the web server in the pre-connection list (operation S421). When there is no pre-connection list for the first web application or no web server information in the pre-connection list, the electronic device 101 may terminate the operation for web server pre-connection. For example, the electronic device 101 may identify the pre-connection list 300 for the first web application, and the pre-connection list 330 may include a first web server 103a, a second web server 103b, and a third web server 103c.

In operation S421, the electronic device 101 according to an embodiment may initiate a communication connection with at least one web server based on the pre-connection list of the first web application. According to an embodiment, in the pre-connection process, only data communication establishment may be performed without a request for data (web resource) transmission/reception between the electronic device 101 and the web server. For example, when communicating with the web server based on the HTTPS protocol, the electronic device 101 may perform domain address identification (e.g., domain name service (DNS) lookup), communication connection identification (e.g., transmission control protocol (TCP) handshake), and communication security connection (e.g., transport layer security (TLS)) for web servers on the pre-connection list. According to an embodiment, the electronic device 101 may provide a state in which data may be immediately transmitted and received in response to a URL request for the corresponding web server being generated according to the default web resource (Home URL) parsing after performing the pre-connection with the web server. For example, the electronic device 101 may initiate a communication connection with the first web server 103a, the second web server 103b, and the third web server 103c. The electronic device 101 according to an embodiment may establish a communication channel with the web server in advance for data transmission and reception.

In operation S430, the electronic device 101 according to an embodiment may parse the web resource (e.g., a page) for the Home URL. Some types of web resources may include other web resource requests. An additional URL request may be generated while the electronic device 101 parses the web resource. For example, referring to FIG. 3, while the electronic device 101 parses the first page 310a, web resource requests (URL requests) to the first web server 103a and the second web server 103b may be generated sequentially.

In operation S440, the electronic device 101 according to an embodiment may detect whether another web resource request (URL request) is generated while parsing the web resource.

In operation S450, if a URL request is generated, the electronic device 101 according to an embodiment may identify whether the web server corresponding to the requested URL request is currently in connection. The electronic device 101 according to an embodiment may identify whether the web server corresponding to the requested URL request is included in the pre-connection server list. For example, referring to FIG. 3, when a URL request to the third web server 103c is generated on the second page 310b, the electronic device 101 according to an embodiment may identify the current connection status by identifying whether the third web server 103c is included on the pre-connection server list 330. The electronic device 101 according to an embodiment may identify whether the web server corresponding to the URL request made through the communication interface is currently in connection.

In operation S460, the electronic device 101 according to an embodiment may directly transmit and receive data (e.g., web resources) to/from the web server when the web server corresponding to the requested URL request is currently in connection.

In operation S451, the electronic device 101 according to an embodiment may initiate a communication connection with the web server when the web server corresponding to the requested URL request is not currently in connection. For example, when communication-connecting with the web server based on the HTTPS protocol, the electronic device 101 may perform DNS lookup, TCP handshake, and TLS processes for the web server. The electronic device 101 may transmit and receive data to/from the corresponding web server (operation S460).

In operation S470, the electronic device 101 according to an embodiment may parse resources for connection to the home URL, obtain all data for home screen rendering from web servers and, if the initialization process for the first web application is completed, display the home screen (start screen) through the display.

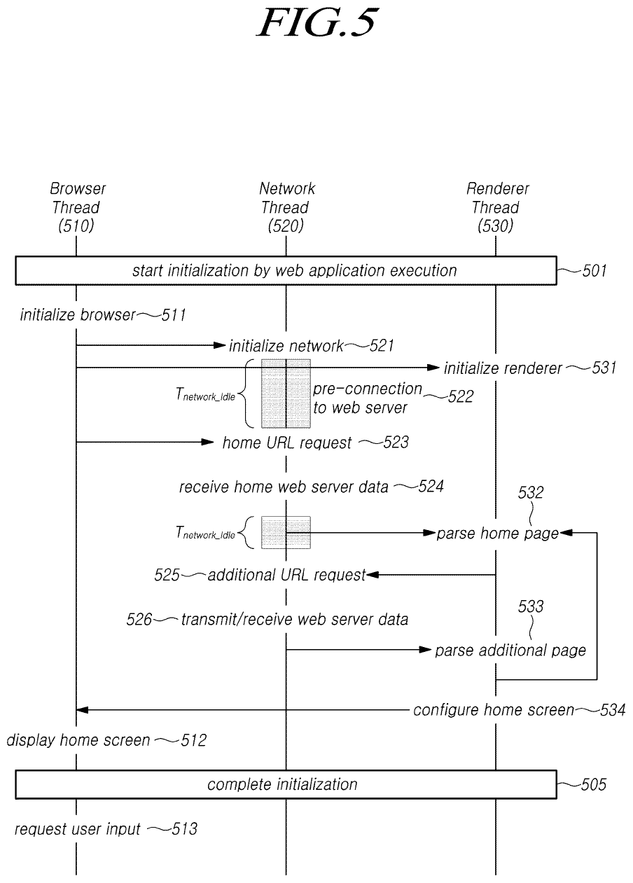

FIG. 5 is a flowchart illustrating operations of a plurality of threads according to web application start of an electronic device according to an embodiment.

According to an embodiment, the electronic device 101 or the processor of the electronic device 101 (hereinafter, referred to as the processor may generate a plurality of threads according to a start request for the web application and control the plurality of threads, respectively, to perform various initialization operations related to the web application. An embodiment in which the processor of the electronic device 101 performs an initialization operation by executing the web application is described with reference to FIG. 5.

In operation 501, in response to a request to start (or launch) the web application, the processor may generate a browser thread 510, a network thread 520, and a renderer thread 530 to control to perform various initialization operations for executing the web application. Since the threads 510, 520, and 530 performs task in parallel, one or more threads may be running at the same time.

In operation 511, the processor may control to start an initialization operation related to the browser through the browser thread 510. According to an embodiment, the browser thread 510 may perform a series of operations of executing an Internet web browser (e.g., home URL) corresponding to the web application. For example, the browser thread 510 may perform various initializations, web engine initializations, and web application window settings related to web applications.

In operation 521, the processor may generate (or fork) the network thread 520 from the browser thread 510 to control to start an initialization operation related to the network. According to an embodiment, in response to a web resource request (e.g., a URL request), the network thread 520 may receive data (e.g., a web page) by communicating with the web server corresponding to the web resource request. If a predetermined initialization operation is completed by operation 521, the network thread 520 may be in a network idle state until receiving another web resource request (e.g., a URL request).

In operation 531, the processor may generate (or fork) the renderer thread 530 from the browser thread 510 to control to start an initialization operation related to rendering. According to an embodiment, the renderer thread 530 may perform operations for interpreting (or parsing) and displaying the page (web resource) received from the web server on a screen. The renderer thread 530 may request the network thread 520 if there is a new URL request during page parsing.

In operation 522, the network thread 520 may establish a pre-communication connection with one or more web servers included in the pre-connection server list corresponding to the web application in response to the network thread 520 is in an idle state T_{network_Idle} after the network initialization operation is completed. For example, when the network thread 520 communicates with the web server based on the HTTPS protocol, the network thread 520 may perform, in advance, only DNS lookup, TCP handshake, and TLS processes for the first web server included in the pre-connection server list. Since the network thread 520 establishes only a communication connection with the web server without transmitting or receiving data, it may initiate a communication connection with a plurality of web servers in a relatively short time. According to an embodiment, the network thread 520 is in a standby state for data transmission and reception with the communication-connected web server and, if the web resource request (e.g., a URL request) is received for the web server, data (e.g., web resource) may be transmitted and received immediately. In the case of pre-connection, the network thread 520 performs only a communication connection with the web server because there is no data transmission/reception request, unlike a URL request by page parsing, and operation 522 does not include data transmission/reception.

In operation 523, the browser thread 510 may request the network thread 520 for a home screen (which may also be referred to as a home page) corresponding to the web application during the browser initialization operation.

In operation 524, the network thread 520 may receive data (home page) from the home web server in response to the home screen request. According to an embodiment, the network thread 520 may transmit the received home page to the renderer thread 530 (operation 532). According to an embodiment, when data transmission/reception with the home web server is completed, the network thread 520 may turn back to the network idle state T_{network_Idle}. Since the threads perform the task parallel, when the network thread 520 receives a home URL request by operation 523 before the communication connection with the web servers included in the pre-connection server list is completed in operation 522, the communication connection to some web servers included in the pre-connection server list may not be established. The network thread 520 may continuously perform a pre-communication connection operation for the web servers remaining in the pre-connection server list after operation 524.

In operation 532, the renderer thread 530 may parse the received home page. According to an embodiment, if there is an additional URL request while parsing the home page, the renderer thread 530 may request the network thread 520 (operation 525).

In operation 525, in response to receiving the additional URL request, when the web server corresponding to the additional URL is included in the pre-connection server list, a communication connection with the corresponding web server has already been established, so that the network thread 520 may be in the data transmission/reception state. According to an embodiment, the network thread 520 may receive data (additional page) from the web server corresponding to the additional URL and transmit it to the renderer thread 530 (operation 533).

In operation 533, the renderer thread 530 may parse the received additional page. According to an embodiment, if the parsing of the additional page is completed, the renderer thread 530 may continuously perform parsing on the rest of the homepage (operation 532).

In operation 534, if parsing for the home page is completed, the renderer thread 530 may configure (render) the home screen based on the received resources to display the home screen.

In operation 512, if rendering on the home screen is completed, the browser thread 510 may display the home screen through the browser.

According to an embodiment, if the home screen (start screen) is displayed by the start request of the web application, the initialization may be completed (operation 505).

In operation 513, the browser thread 510 may be in a state of waiting for a user input request. According to an embodiment, the start screen may include various user interfaces and may execute various functions in response to an input user input.

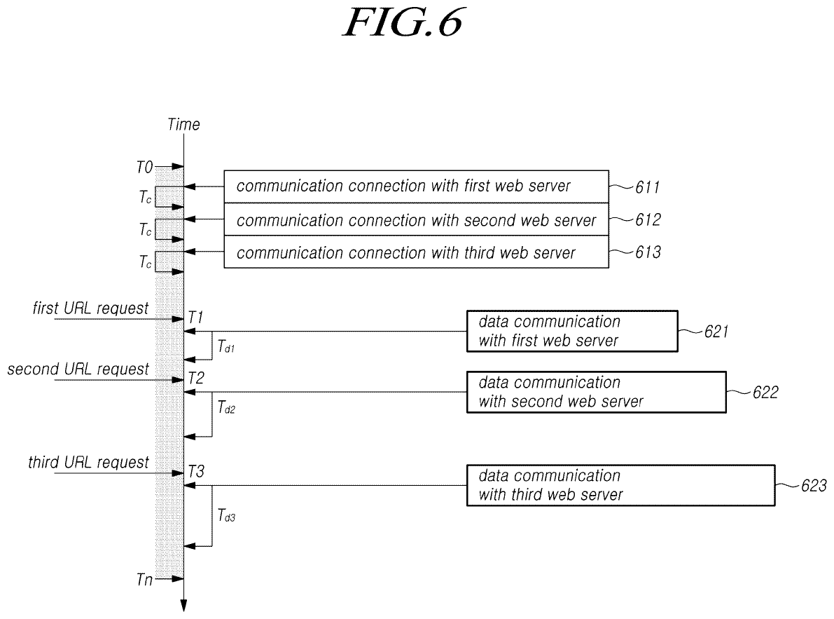

FIG. 6 illustrates an example of a network thread operation according to start of a web application on an electronic device according to an embodiment.

A series of operations performed by the network thread 520 in response to a start request for the web application in the electronic device 101 according to an embodiment are described with reference to FIG. 6. As an example, each operation of FIG. 6 may be described with reference to FIGS. 3 and 5 together.

The network thread 520 according to an embodiment may be generated by the processor of the electronic device 101. The network thread 520 may perform a series of operations related to network initialization in response to the start request of the first web application. While parsing the home page (e.g., the first page 310a of FIG. 3) of the first web application in the renderer thread 530, one or more URL requests (e.g., the second web server 130b of FIG. 3, the third web server 130c of FIG. 3, and the second page 310b of FIG. 3) may be identified. The network thread 520 may receive and process one or more URL requests from the renderer thread 530.

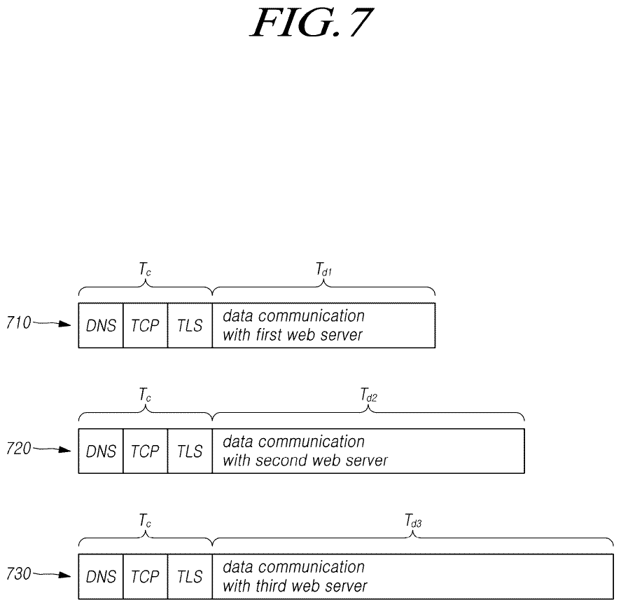

In operations 611, 612, and 613, the network thread 520 may initiate a pre-connection with the first web server, the second web server, and the third web server included in the first pre-connection server list 330 corresponding to the first web application at a network thread generation time T0. For example, when communicating with the web server based on the HTTPS protocol, the network thread 520 may perform DNS lookup, TCP handshake, and TLS operations to establish a communication connection with the first web server, the second web server, and the third web server. The communication connection is further described with reference to FIG. 7 below.

FIG. 7 illustrates an example of a data communication time between an electronic device 101 and a web server according to an embodiment.

According to an embodiment, a communication time between the electronic device 101 and the web server may be divided into a communication connection time T_{c} and a data transmission time T_{d}. The communication connection time T_{c} refers to the time it takes for the electronic device 101 to complete the connection establishment to initiate communication with the web server, and for example, when communicating with the web server based on the HTTPS protocol, may include network connection establishment, TCP/IP connection establishment, SSL/TLS handshake, or the like. The data transmission time T_{d} refers to a time when actual data transmission is performed after a connection is established, and may include a time taken for data packets to be transmitted/received and processed.

According to an embodiment, when communicating with the web server based on the HTTPS protocol, the communication time 710 between the electronic device 101 and the first web server may be divided into a communication connection time T_{c} including DNS, TCP, and TLS work time and a data transmission time T_{d1} for data communication with the first web server by a URL request. According to an embodiment, when communicating with the web server based on the HTTPS protocol, the communication time 720 between the electronic device 101 and the second web server may be divided into a communication connection time T_{c} including DNS, TCP, and TLS work time and a data transmission time T_{d2} for data communication with the second web server by a URL request. According to an embodiment, when communicating with the web server based on the HTTPS protocol, the communication time 730 between the electronic device 101 and the third web server may be divided into a communication connection time T_{c} including DNS, TCP, and TLS work time and a data transmission time T_{d3} that communicates with the third web server by a URL request.

According to an embodiment, the data transmission times T_{d1}, T_{d2}, and T_{d3} between the electronic device 101 and each web server may be different from each other because they are proportional to the amount of each data (e.g., page). Although it may be partially affected by the network communication environment or the delay time of the web server, the communication connection time T_{c} between the electronic device 101 and each web server may be substantially the same compared to the data transmission times.

According to an embodiment, the communication connection time T_{c} may be relatively shorter than the data transmission times T_{d1}, T_{d2}, and T_{d3}. When the network thread 520 is busy, even a relatively short communication connection time T_{c} may be burdensome to the network, and when a delay occurs due to the communication connection time T_{c}, operations (e.g., parsing operation or rendering operation) after communication connection may be significantly affected.

Referring back to FIG. 6, in operations 611, 612, and 613, the network thread 520 generated by the processor of the electronic device 101 may initiate pre-connection with the web servers included in the first pre-connect server list. According to an embodiment, the network thread 520 may perform, in advance, a communication connection with the first web server included in the first pre-connection server list immediately at the time T0 of generation by the start of the first web application (operation 611). Before the first URL request to the first web server is generated, the network thread 520 may complete the communication connection with the first web server. The network thread 520 may perform data communication with the first web server immediately at the time T1 when the first URL request for the first web server is generated.

According to an embodiment, a URL request may be received from at least one of the browser thread 510 or the renderer thread 530 working in parallel with the network thread 520.

In operation 621, since the network thread 520 is already communicatively connected to the first web server, the network thread 520 may immediately receive data in response to the first URL request, within the data transmission time T_{d1}.

In operation 622, since the network thread 520 is already communicatively connected to the second web server, the network thread 520 may immediately receive data in response to the second URL request, within the data transmission time T_{d2}.

In operation 623, since the network thread 520 is already communicatively connected to the third web server, it may immediately receive data in response to the third URL request, within the data transmission time T_{d3}.

The initialization of the first web application may be completed at an initialization time Tn. According to an embodiment, since only the data transmission times T_{d1}, T_{d2}, and T_{d3} are used in response to the URL request, the total initialization time T0 to Tn of the first web application may be reduced.

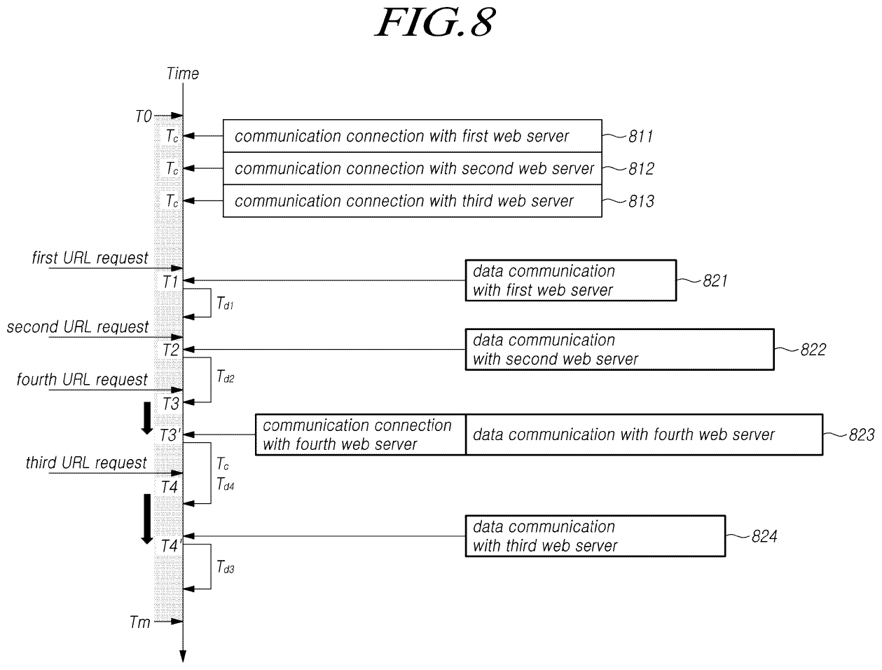

FIG. 8 illustrates another example of a network thread operation according to start of a web application on an electronic device according to an embodiment.

A series of operations performed by the network thread 520 in response to a start request for the web application in the electronic device 101 according to an embodiment are described with reference to FIG. 8. For convenience of description, the description focuses on the differences from the embodiment described in FIG. 6.

Referring to FIGS. 6 and 8 together, in operations 811, 812, and 813, the electronic device 101 according to an embodiment may initiate a pre-connection with the first web server, the second web server, and the third web server included in the first pre-connection server list corresponding to the first web application in response to a request to start the first web application. Operation 811, operation 812, and operation 813 may be described corresponding to operation 611, operation 612, and operation 613, respectively, of FIG. 6.

In operation 821, according to an embodiment, the network thread 520 may immediately perform data communication with the first web server that is already communication-connected in response to the first URL request. Operations 821 and 822 may be described corresponding to operations 621 and 622, respectively, of FIG. 6.

In operation 823, according to an embodiment, the network thread 520 may receive the fourth URL request at the third time T3 before data reception with the second web server is completed. The network thread 520 may execute a series of operations according to the fourth URL request after operation 822 is completed. According to an embodiment, after data reception with the second server is completed (T3′), the network thread 520 may identify a fourth web server corresponding to the fourth URL request and establish a communication connection with the fourth web server, within the communication connection time T_{c}. If the fourth web server is connected, the network thread 520 may receive data from the fourth web server, within the data transmission time T_{d4}. For example, when communicating with the web server based on the HTTPS protocol, the network thread 520 may sequentially perform DNS lookup, TCP handshake, TLS, and data reception operations on the fourth web server. According to an embodiment, since the fourth URL request is not included in the first pre-connection server list, a communication connection with the fourth web server in the network idle state may not already be established.

In operation 824, according to an embodiment, the network thread 520 may receive the third URL request at the fourth time T4 before the data reception with the fourth web server in operation 823 is completed. The network thread 520 may execute a series of operations according to the third URL request after operation 823 is completed. According to an embodiment, the network thread 520 may start operations for processing the third URL request after operation 823 is completed (T4′). According to an embodiment, the network thread 520 may immediately perform data communication with the third web server that is already communication-connected in response to the third URL request. Operation 824 may be described corresponding to operation 623 of FIG. 6.

Unlike FIG. 6, in FIG. 8, the initialization time Tm may be longer than the initialization time Tn of the first web application. Referring to FIG. 8, in addition to a condition in which a URL request to be processed is added, a delay may occur in the process of processing the added URL request. According to an embodiment, although parallel processing between threads may be used, when interaction between threads is delayed, the total initialization time may be increased. For example, if the loading of the URL page is delayed in the network thread 520, the parsing of the URL page in the renderer thread 530 may also be delayed.

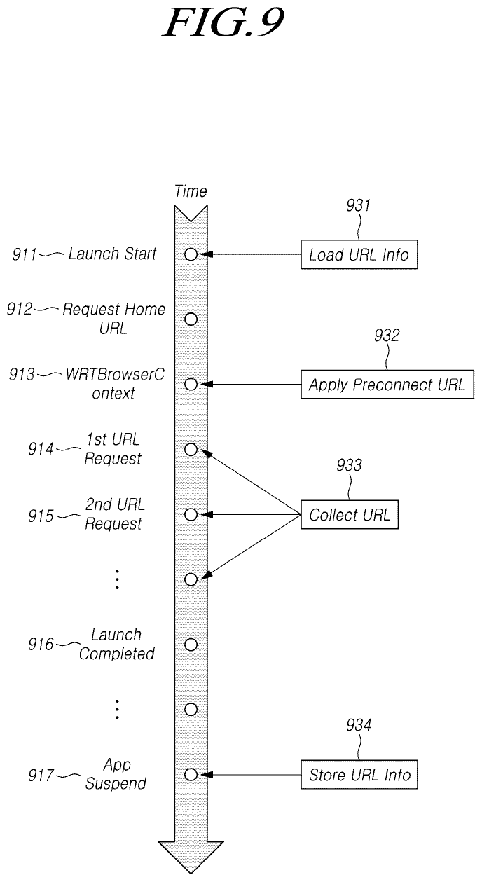

FIG. 9 illustrates an example of an operation of managing a pre-connection server list for a web application by an electronic device according to an embodiment.

Referring to FIG. 9, operations (operations 931 to 934) of managing the pre-connection server list with respect to steps (operations 911 to 917) in which the electronic device 101 or the processor of the electronic device 101 (hereinafter, referred to as the processor) according to an embodiment performs a series of operations to display the home page in response to the web application start request are described. The processor according to an embodiment may process at least some of operations 911 to 917 and operations 931 to 934 in parallel through a plurality of threads.

The processor according to an embodiment may store information about accessed web servers as the pre-connection server list while displaying the home page in response to the start request of the first web application. At least a portion of the start screen of the first web application may be changed over time. For example, the start screen of the first web application may be updated by the producer who creates and distributes the web application. The processor according to an embodiment may identify whether to update the pre-connection server list of the first web application at each start execution of the first web application.

In operation 911, according to an embodiment, the processor may start the first web application.

In operation 931, according to an embodiment, the processor may load a first pre-connection server list (URL Info) pre-stored in the memory at the beginning of the start of the first web application through a separate thread (e.g., the network thread) from the thread (e.g., the browser thread) performing operation 911. The first pre-connection server list may include information (URL request) about the web server that has been accessed at the initialization step in the previous execution of the first web application. The processor may initiate pre-connection based on the first pre-connection server list. The pre-connection server list may be separately stored for each web application, and may be included in a non-volatile memory or a storage medium.

In operation 912, the processor according to an embodiment may process a home URL request corresponding to the first web application. The processor may receive and parse a home page (home screen or start screen) from a home web server corresponding to the home URL.

In operation 913, according to an embodiment, the processor may perform a series of operations (web rendering thread (WRT)) for generating a home browser through the browser thread, the network thread, or the renderer thread.

In operation 932, the processor according to an embodiment may apply pre-connection with the web servers included in the first pre-connection server list through the network thread (apply pre-connection URL). For example, the processor may attempt pre-connection with the web servers included in the first pre-connection server list loaded through the network thread in the idle state immediately after browser content is generated by the browser thread.

In operations 914 and 915, according to an embodiment, the processor may sequentially receive and process web resource requests (a first URL request and a second URL request). The web servers corresponding to the first URL request and the second URL request may be included in the first pre-connection server list. The processor according to an embodiment may quickly load a page from a pre-connected web server.

In operation 933, the processor according to an embodiment may collect requested web resource (e.g., URL) information during the launch operation according to the start of the first web application (collect URL). According to an embodiment, the processor may store and manage the collected web resource information as the pre-connection server list. The processor according to an embodiment may limit the number of web servers to initiate pre-connection. The first pre-connection server list may include a predetermined number of URL information. When the number of web servers performing pre-connection is large, performance degradation due to pre-connection may rather occur. The processor according to an embodiment may determine the limit of the first pre-connection server list considering the performance of the pre-connection and the number of web servers used in the launching process according to the start of the web application.

In operation 916, the processor according to an embodiment may output a home screen (start screen) after all initialization of the first web application is completed, and may wait for a user input.

In operation 917, the processor according to an embodiment may terminate the first web application or switch the first web application to a background state in response to a user input of activating another application (app suspend).

In operation 934, the processor according to an embodiment may store the first pre-connection server list collected by operation 933 after operation 916 or after operation 917 in the memory (store URL Info). The first pre-connection server list may be stored in a non-volatile memory or a separate storage so that the first pre-connection server list may be loaded at the next start execution of the first web application.

The processor according to an embodiment may maintain and update the first pre-connection server list by performing operations 931, 932, 933, and 934 at each execution of the first web application.

In the case of initial execution of the first web application, the processor according to an embodiment may generate a new first pre-connection server list. Since the pre-connection process may not be performed, operations 933 and 934 may be performed.

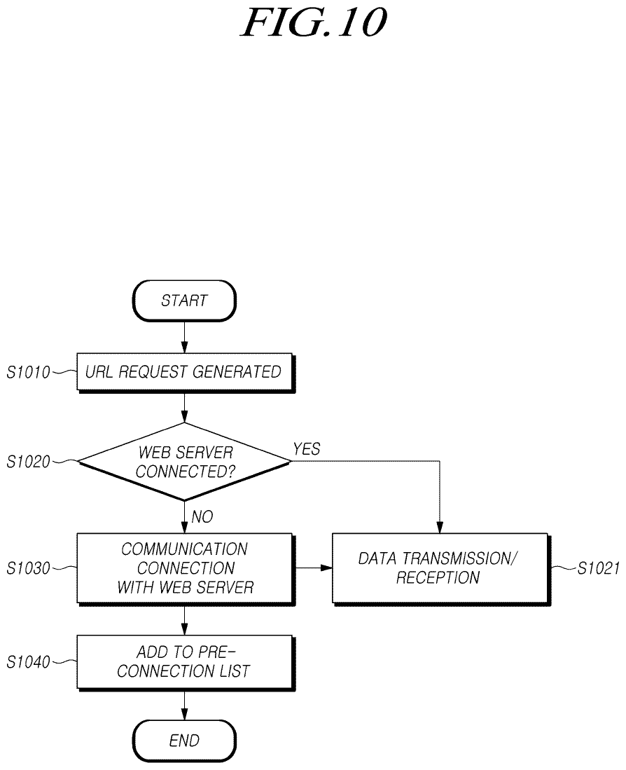

FIG. 10 is a flowchart illustrating operations of processing a URL request of a web application by an electronic device according to an embodiment.

According to an embodiment, the electronic device 101 or the processor of the electronic device 101 (hereinafter, referred to as the processor) may establish a communication connection with the web servers included in the pre-connection server list in advance at the beginning of the web application initialization and immediately receive data from the already connected web servers at the time of processing a URL request generated during page parsing. An operation of processing a URL request according to execution of the web application in the electronic device 101 according to an embodiment is described. As an example, each operation of FIG. 10 may be described with reference to FIG. 8 as well.

In operation S1010, the processor according to an embodiment may detect the generation of a URL request. For example, the processor may receive a first URL request, a second URL request, a fourth URL request, or a third URL request of FIG. 8.

In operation S1020, the processor according to an embodiment may identify the web server corresponding to the URL request and identify whether the web server is in connection. For example, the processor may identify a first web server corresponding to the first URL request and identify that the first web server is in connection. In another example of FIG. 8, the processor may identify the fourth web server corresponding to the fourth URL request and identify that the fourth web server is not connected.

In operation S1021, the processor according to an embodiment may immediately receive data from the corresponding web server in response to identifying that the web server corresponding to the requested URL is in connection. For example, referring to FIG. 8, the processor may immediately receive data from the first web server at the first URL request time T1.

In operation S1030, the processor according to an embodiment may perform data communication after establishing a communication connection with the web server in response to identifying that the web server corresponding to the requested URL is not connected. For example, referring to FIG. 8, the processor may receive data from the fourth web server after establishing a communication connection with the fourth web server in response to the fourth URL request (operation 823).

In operation S1040, the processor according to an embodiment may establish a communication connection by a URL request, and then add URL information about the web server receiving data to the pre-connection server list. The processor according to an embodiment may collect and store information about web servers accessed in the initial loading process of the web application, and apply the same to the pre-connection of the next execution of the web application.

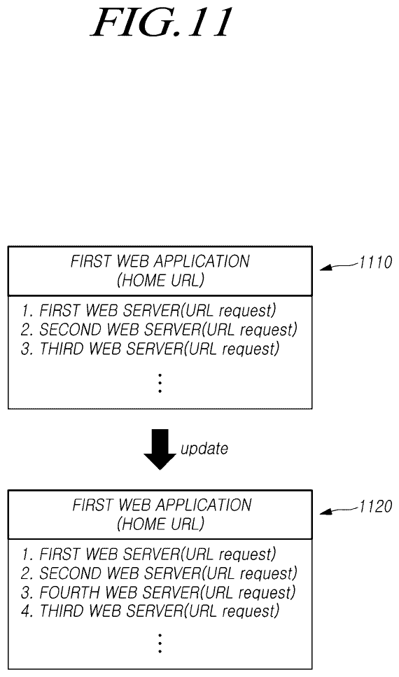

FIG. 11 illustrates an example of a pre-connection server list update for a web application on an electronic device according to an embodiment.

The electronic device 101 according to an embodiment may store and update the pre-connection server list in order to apply information about the web server accessed in the initial loading process as the pre-connection target of the next execution at each execution of the web application. As an example, it may be described with reference to FIG. 8.

Referring to FIG. 11, the first pre-connection server list 1110 for the first web application may include a first web server (URL request), a second web server (URL request), and a third web server (URL request). The web servers included in the first pre-connection server list 1110 may correspond to web servers accessed at the previous execution of the first web application. The order stored in the first pre-connection server list 1110 may be an order of accessing each web server in the process of executing the web application. For example, the first web server may be the first web server accessed in the execution process of the first web application.

The electronic device 101 according to an embodiment may add the fourth web server to update the same as the first pre-connection server list 1120 by reflecting the current execution of the first web application. For example, referring to FIG. 8, the electronic device 101 according to an embodiment may receive a fourth URL request at the time T3 and perform data communication with the fourth web server. The electronic device 101 may store the pre-connection server list 1120 to which the fourth web server is added in the memory when initialization of the first web application is completed or when it is in a background state with respect to the fourth web server that is not pre-connected.

At the current execution of the first web application, the electronic device 101 according to an embodiment may remove the corresponding web server, which is included in the first pre-connection server list 1110 to be pre-connected, but does not generate a corresponding URL request, from the first pre-connection server list 1110.

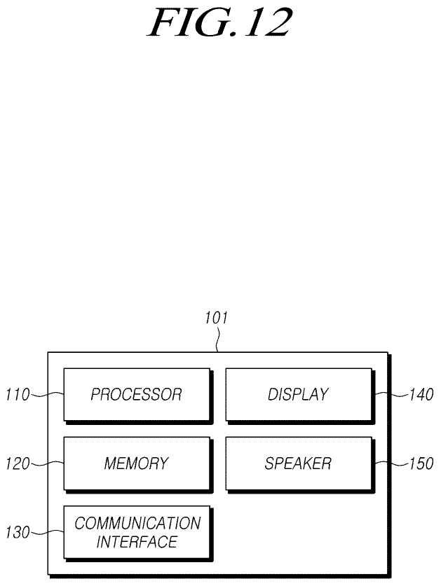

FIG. 12 is a block diagram illustrating components of an electronic device according to an embodiment.

An electronic device 101 according to an embodiment may include at least some of a processor 110, a memory 120, a communication interface 130, a display 140, or a speaker 150. For example, the communication interface 130 may be implemented by any one or any combination of a digital modem, a radio frequency (RF) modem, an antenna circuit, a WiFi chip, and related software and/or firmware.

The processor 110 may execute, for example, software (e.g., a program) to control at least one other component (e.g., a hardware or software component) of the electronic device 101 coupled with the processor 110, and may perform various data processing or computation. According to one embodiment, as at least part of the data processing or computation, the processor 110 may load a command or data received from another component (e.g., communication interface 130) onto a volatile memory, process the command or the data stored in the volatile memory, and store resulting data in a non-volatile memory. According to an embodiment, the processor 110 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor.

The memory 120 may store various data used by at least one component (e.g., the processor 110 or the communication interface 130) of the electronic device 101. The data may include, e.g., input data or output data for software (e.g., a program) and related commands. The memory 120 may include volatile memory or nonvolatile memory.

The program may be stored, as software, in the memory 120 and may include, e.g., an operating system (OS), middleware, or an application. According to an example, the memory 120 may store various pieces of information or data related to an operation of the electronic device 101, and may store at least one program.

The communication interface 130 may include a wireless communication interface (e.g., a cellular communication interface, a short-range wireless communication interface, or a global navigation satellite system (GNSS) communication interface) or a wired communication interface (e.g., a local area network (LAN) communication interface, or a power line communication interface). A corresponding one of these communication interfaces may communicate with the external electronic device (e.g., the server 103a) via a short-range communication network (e.g., Bluetooth, wireless-fidelity (Wi-Fi) direct, or infrared data association (IrDA)) or a long-range communication network (e.g., a legacy cellular network, a 5G network, a next-generation communication network, the Internet, or a computer network (e.g., LAN or WAN).

The wireless communication interface may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication interface may support a high-frequency band (e.g., the mmWave band) to achieve, e.g., a high data transmission rate.

The display 140 may visually provide information to the outside (e.g., the user) of the electronic device 101. The display 140 may include, for example, a display, a hologram device, or a projector and control circuitry to control a corresponding one of the display, hologram device, and projector. According to an embodiment, the display 140 may include a touch sensor configured to detect a touch, or a pressure sensor configured to measure the intensity of a force generated by the touch.

A speaker 150 may output sound. When playing various contents provided by the electronic device 101, sound may be output through the speaker 150.

According to an embodiment, the processor 110 of the electronic device 101 may initiate a pre-connection with at least one web server indicated in a first pre-connection server list corresponding to a first web application through a second thread operating in parallel with a first thread while performing at least one initialization operation for executing the first web application through the first thread in response to a launch request of the first web application.

According to an embodiment, the pre-connection may initiate a communication connection with the at least one web server before a web resource request for the at least one web server is generated.

According to an embodiment, the second thread may be a network thread.

According to an embodiment, the at least one processor 110 may control to complete the pre-connection by initiating the communication connection with the at least one web server included in the first pre-connection server list in response to the network thread may be in an idle state after completing network initialization.

According to an embodiment, the first thread may be a browser thread.

According to an embodiment, the browser thread may transmit a first web resource request corresponding to a start screen of the web application to the second thread during a browser initialization operation, receive, via the second thread, a first web resource, render the start screen based on the first web resource, and display, through the display 140, the start screen in response to completion of the initialization of the first web application.

According to an embodiment, performing the pre-connection with the at least one web server included in the first pre-connection server list corresponding to the first web application through the second thread may enable the at least one processor 110 to perform at least one of domain address identification (domain name service (DNS) lookup), communication connection identification (transmission control protocol (TCP) handshake), or communication security connection (transport layer security (TLS)) with respect to the first web server included in the first pre-connection server list based on an HTTPS protocol.

According to an embodiment, the at least one processor 110 may identify whether the communication connection is established with a first web server corresponding to the first web resource request in response to the second thread receiving the first web resource request from the first thread.

According to an embodiment, the at least one processor 110 may control the second thread to receive a first web resource indicated in the first web resource request from the first web server connected, in response to identifying that the first web server may be in connection.

According to an embodiment, the at least one processor 110 may control the second thread to receive the first web resource indicated in the first web resource request from the first web server after initiating the communication connection with the first web server, in response to identifying that the first web server may be not in connection.

According to an embodiment, the at least one processor 110 may control the second thread to transmit the first web resource received from the first web server to a third thread, and enables the third thread to transmit a second web resource request generated while parsing the first web resource to the second thread.

According to an embodiment, the at least one processor 110 may collect first information about at least one web resource request generated until the at least one initialization operation is completed, the first information comprising information about a web server that initiates a communication connection according to the at least one web resource request, and apply the first information to the first pre-connection server list.

According to an embodiment, the at least one processor 110 may store the first pre-connection server list in the memory 120 at a time when the initialization of the first web application is completed or a time when the first web application becomes a background state.

According to an embodiment, the memory may be a non-volatile memory or a separate storage.

According to an embodiment, the start screen of the first web application may include at least one user interface.

According to an embodiment, a method by an electronic device 101 may comprise performing at least one initialization operation to execute a first web application through a first thread in response to a launch request of the first web application, by a processor 110 of the electronic device, and performing a pre-connection with at least one web server indicated in a first pre-connection server list corresponding to the first web application through a second thread operating in parallel with the first thread while the first thread performs the at least one initialization operation.

According to an embodiment, the pre-connection may initiate a communication connection with the at least one web server before a web resource request for the at least one web server is generated.

According to an embodiment, the second thread may be a network thread.

According to an embodiment, the processor 110 of the electronic device 101 may establish the pre-connection by initiating the communication connection with the at least one web server included in the first pre-connection server list in response to the network thread may be in an idle state after completing network initialization.

According to an embodiment, the first thread may be a browser thread.

According to an embodiment, the processor 110 of the electronic device 101 may transmit, through the browser thread, a first web resource request corresponding to a start screen of the first web application to the second thread during a browser initialization operation, receive, via the second thread, a first web resource, render the start screen based on the first web resource, and display, through a display 140 of the electronic device, the start screen in response to completion of the at least one initialization of the first web application.

According to an embodiment, performing the pre-connection with the at least one web server included in the first pre-connection server list corresponding to the first web application through the second thread may enable the processor 110 of the electronic device 101 to perform at least one of domain address identification (domain name service (DNS) lookup), communication connection identification (transmission control protocol (TCP) handshake), or communication security connection (transport layer security (TLS)) with respect to the first web server included in the first pre-connection server list based on an HTTPS protocol.

According to an embodiment, the method may further comprise identifying, by a processor 110 of the electronic device 101, whether the communication connection is established with first web server corresponding to the first web resource request in response to the second thread receiving the first web resource request from the first thread, and controlling the second thread to receive a first web resource indicated in the first web resource request from the first web server, in response to identifying that the first web server may be in connection.

According to an embodiment, the method may further comprise receiving, through the second thread by the processor 110 of the electronic device 101, the first web resource indicated in the first web resource request from the first web server after initiating the communication connection with the first web server, in response to identifying that the communication connection with the first web server is not established.

According to an embodiment, the method may further comprise controlling the second thread to transmit the first web resource received from the first web server to a third thread, and enabling the third thread to transmit a second web resource request generated while parsing the first web resource to the second thread.

According to an embodiment, the method may further comprise collecting, by the processor 110 of the electronic device 101, first information about a web resource request generated until the initialization of the first web application is completed, the first information including information about a web server that initiates a communication connection according to the web resource request, and applying the first information to the first pre-connection server list.

According to an embodiment, the method may further comprise storing, by the processor 110 of the electronic device 101, the first pre-connection server list in a memory 120 of the electronic device at a time when the initialization of the first web application is completed or a time when the first web application becomes a background state.

According to an embodiment, the memory 120 may be a non-volatile memory or a separate storage.

According to an embodiment, the start screen of the first web application may include at least one user interface.

Terms used herein are not intended to limit the technical features described and should be understood to include various modifications, equivalents, or substitutes of the described embodiments. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-integrated circuit (ASIC).

An embodiment may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more other components may be added. A plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order, or one or more other operations may be added.

What is claimed is:

1. An electronic device, comprising:
memory storing instructions; and
at least one processor,
wherein the instructions, when executed by the at least one processor, cause the electronic device to:
initiate, via a second thread operating in parallel with a first thread, a pre-connection with at least one web server indicated in a first pre-connection server list of a first web application, while performing, via the first thread, at least one initialization operation for executing the first web application based on a launch request of the first web application; and
enable a communication connection, via the pre-connection, to the at least one web server, before a web resource request for the at least one web server is generated.

2. The electronic device of claim 1, wherein the second thread is a network thread, and
wherein the instructions, when executed by the at least one processor, cause the electronic device to establish the pre-connection, via the communication connection, in response to the network thread is in an idle state, after network initialization operation is completed.

3. The electronic device of claim 1, further comprising a display,
wherein the first thread is a browser thread, and
wherein the instructions, when executed by the at least one processor, cause the electronic device to:
transmit to the second thread, via the browser thread, a first web resource request corresponding to a start screen of the first web application, during a browser initialization operation;
receive, via the second thread, a first web resource;
render the start screen based on the first web resource, and
display, via the display, the start screen.

4. The electronic device of claim 1, wherein the instructions, when executed by the at least one processor, cause the electronic device to enable, based on the pre-connection and an HTTPS protocol, with respect to the at least one web server, at least one of:
domain address identification comprising a domain name service (DNS) lookup,
communication connection identification comprising a transmission control protocol (TCP) handshake, or
communication security connection initialization comprising transport layer security (TLS).

5. The electronic device of claim 1, wherein the instructions, when executed by the at least one processor, cause the electronic device to:
identify, based on the second thread receiving the first web resource request from the first thread, whether the communication connection is established with a first web server corresponding to the first web resource request; and
receive, via the second thread, based on the communication connection being established, a first web resource indicated in the first web resource request from the first web server.

6. The electronic device of claim 5, wherein the instructions, when executed by the at least one processor, cause the electronic device to receive the first web resource from the first web server, via the second thread, after initiating the communication connection with the first web server, based on determining the communication connection with the first web server is not established.

7. The electronic device of claim 5, wherein the instructions, when executed by the at least one processor, cause the electronic device to:
transmit the first web resource to a third thread, via the second thread; and
transmit, via the third thread, a second web resource request to the second thread, wherein the second web resource request is generated while the first web resource is being parsed.

8. The electronic device of claim 1, wherein the instructions, when executed by the at least one processor, cause the electronic device to:
collect first information, about at least one web resource request, that is generated until the at least one initialization operation is completed, the information comprising information about a web server that initiates a communication connection according to the at least one web resource request; and
apply the information that is collected to the first pre-connection server list.

9. The electronic device of claim 8, wherein the memory comprises a first memory that is at least one of a non-volatile memory or a separate storage, and
wherein the instructions, when executed by the at least one processor, cause the electronic device to store the first pre-connection server list in the memory at a first time based on the at least one initialization operation being completed or a second time based on the first web application having transitioned to a background state.

10. The electronic device of claim 3, wherein the start screen comprises at least one user interface, and
wherein the start screen comprises one or more consecutive screens.

11. A method performed by an electronic device comprising:
initiating, via a second thread operating in parallel with a first thread, a pre-connection with at least one web server indicated in a first pre-connection server list of a first web application, while performing, via the first thread, at least one initialization operation for executing the first web application based on a launch request of the first web application; and
enabling a communication connection, via the pre-connection, to the at least one web server, before a web resource request for the at least one web server is generated.

12. The method of claim 11, wherein the second thread is a network thread, and
wherein the method further comprises establishing the pre-connection, via the communication connection, in response to the network thread is in an idle state, after the at least one network initialization operation is completed.

13. The method of claim 11, wherein the first thread is a browser thread, and
wherein the method further comprises:
transmitting, to the second thread via the browser thread, a first web resource request corresponding to a start screen of the first web application, during a browser initialization operation;
receiving, via the second thread, a first web resource;
rendering the start screen based on the first web resource; and
displaying, via a display of the electronic device, the start screen.

14. The method of claim 11, wherein the performing the pre-connection to the at least one web server comprises enabling, based on the pre-connection and an HTTPS protocol, with respect to a first web server, at least one of:
domain address identification comprising a domain name service (DNS) lookup,
communication connection identification comprising a transmission control protocol (TCP) handshake, or
communication security connection initialization comprising transport layer security (TLS).

15. The method of claim 13, further comprising:
identifying, based on the second thread receiving the first web resource request from the first thread, whether the communication connection is established with a first web server corresponding to the first web resource request; and
receiving, via the second thread, based on the communication connection being established, a first web resource indicated in the first web resource request from the first web server.

16. The method of claim 15, further comprising receiving the first web resource from the first web server, via the second thread, after initiating the communication connection with the first web server, based on determining the communication connection with the first web server is not established.

17. The method of claim 15, further comprising:
transmitting the first web resource to a third thread, via the second thread; and
transmitting, via the third thread, a second web resource request to the second thread, wherein the second web resource request is generated while the first web resource is being parsed.

18. The method of claim 13, further comprising:
collecting first information, about the web resource request, that is generated until the at least one initialization operation is completed, wherein the first information comprising information about a web server that initiates a communication connection according to the web resource request; and
applying the first information to the first pre-connection server list.

19. The method of claim 18, further comprising storing the first pre-connection server list in memory at a first time based on the at least one initialization operation being completed or a second time based on the first web application having transitioned to a background state, and
wherein the memory is a non-volatile memory or a separate storage device.

20. The method of claim 13, wherein the start screen comprises at least one user interface, and
wherein the start screen comprises one or more consecutive screens.
